(19) United States
(12) Patent Application Publication
(10) Pub. No.: US 2013/0122339 A1
(43) Pub. Date: May 16, 2013

(54) BATTERY

(71) Applicants: Seung Yeub Chae, Incheon (KR); Tae Young Chang, Seoul (KR); Dong Hun Lim, Goyang-si (KR)

(72) Inventors: Seung Yeub Chae, Incheon (KR); Tae Young Chang, Seoul (KR); Jae Cheol Hwang, Seoul (KR); Dong Hun Lim, Goyang-si (KR)

(73) Assignee: V-ENS CO., LTD., Incheon (KR)

(21) Appl. No.: 13/512,280

(22) PCT Filed: Nov. 1, 2010
(86) PCT No.: PCT/KR2010/007577

§ 371 Date: Sep. 25, 2012

(30) Foreign Application Priority Data
Nov. 27, 2009 (KR) 10-2009-0116061
Jul. 9, 2010 (KR) 10-2010-0066341

(51) Int. Cl. H01M 10/50

(52) U.S. Cl. CPC H01M 10/5016
USPC 429/99

(57) ABSTRACT

A battery according to one embodiment of the present invention comprises a battery cartridge module which generates electric current, and which is formed by stacking a plurality of battery cartridges, each of which has a plurality of through holes formed by opening one side thereof; pack brackets which support the battery cartridge modules such that the battery cartridge modules are stacked into a layer; and a plurality of long bolts inserted into the respective through holes such that the long bolts penetrate through the respective battery cartridges and fasten the battery cartridge modules to the pack brackets.

### TECHNICAL FIELD

The present invention relates to a battery, and more particularly to a rechargeable battery in which a plurality of cell cartridges forms a module.

### BACKGROUND ART

One serious problem encountered in vehicles using fossil fuels such as gasoline or light oil is air pollution. As a measure to solve such a problem, a technology for using re-chargeable secondary cells as a power source for vehicles is receiving attention. Thus, an electric vehicle (EV), which can be driven only using a battery, a hybrid electric vehicle (HEV), which uses a battery in combination with a conventional combustion engine, or the like has been developed, and is commercially available. For secondary cells as a power source of EVs, HEVs, or the like, nickel metal hydride (Ni-MH) cells are mainly used. Recently, use of lithium ion cells has also been attempted.

In order to be used as a power source of EVs, HEVs, or the like, the cells should have high power and large capacity. To this end, a medium or large cell pack having a structure, in which a plurality of small secondary cells (unit cells) is connected in series and/or in parallel, is used. Since unit cells used in the medium or large cell pack are stacked at high density, a prismatic cell or a pouch type cell, which is capable of reducing the size of a dead space, is used as such a unit cell.

In order to achieve easy mechanical fastening and easy electrical connection of unit cells as mentioned above, a cell cartridge capable of mounting one unit cell or two or more unit cells is generally used. That is, a plurality of cell cartridges, in which unit cells are mounted, is stacked to faun a cell pack.

For a medium or large cell pack formed by stacking a plurality of cell cartridges, there are various cell cartridge stacking or connection methods. Such methods require many components and a number of processing tasks.

Therefore, it is necessary to simplify the structure of cell cartridges to be formed into a medium or large cell pack while achieving stable stacking of the cell cartridges. It is also necessary to more easily achieve the process of completing the medium or large cell pack through handling of a plurality of cell cartridges under the condition that the cell cartridges are formed into a single module.

In addition, it is necessary to achieve an enhancement in the efficiency of plural cell cartridges by effectively removing heat generated from the cell cartridges.

### DISCLOSURE

### Technical Problem

It is an object of the present invention to provide a rechargeable battery in which a plurality of cell cartridges forms a module.

It is another object of the present invention to provide a battery capable of achieving an enhancement in efficiency of cell cartridges through effective cooling of the cell cartridges.

The objects of the present invention are not limited to the above-described objects, and other objects not described will be more clearly understood by those skilled in the art from the following description.

### Technical Solution

In accordance with an aspect of the present invention, the above and other objects can be accomplished by the provision of a battery including a cell cartridge module formed by stacking a plurality of cell cartridges, each of which generates current and is formed with a plurality of through holes at sides thereof, a pack bracket for supporting the cell cartridge module, to enable stacking of the cell cartridge module, and a plurality of long bolts inserted into the through holes, to extend through the cell cartridges so as to fasten the cell cartridge module to the pack bracket.

Detailed matters of other embodiments are included in the detailed description and the drawings.

### Advantageous Effects

In accordance with the battery of the present invention, there are one or more effects as follows.

First, it is possible to effectively dissipate heat generated from the cell cartridges because the cooling plate is provided at one side of the cell cartridge module.

Second, it is possible to rapidly transfer heat generated from the unit cells because the heat sink plate is provided in each cell cartridge.

Third, heat generated from each unit cell is effectively transferred to the cooling plate because the heat sink plate is formed to enclose the unit cell.

Fourth, heat generated from the heat sink plate is effectively transferred to the cooling plate because the thermal pad is provided between the heat sink plate and the cooling plate in a pressed state.

Fifth, it is possible to integrally couple the cell cartridge module and cooling plate because the pack bracket is provided with the cooling plate portion.

Sixth, the bus bar module provided at the cell cartridge modules is coupled with the pack bracket in a state in which the cell cartridge modules are fastened to the pack bracket by the long bolts. Accordingly, a battery, individual components of which are firmly coupled, is completed. Thus, it is possible to manufacture a single sub-pack module for constituting a medium or large cell pack, in a simple and convenient manner in terms of structure, while reducing the number of processing tasks.

Seventh, a plurality of guides supports corners of each cell cartridge module such that the cell cartridge module seated on the pack bracket is firmly supported by the pack bracket. Accordingly, it is possible to prevent each cell cartridge module from being damaged due to movement thereof caused by external impact or vibration.

Eighth, the peripheral portion contacts the peripheral portions of the cell cartridge modules along the inner surface of the peripheral portion, to support the peripheral portions of the cell cartridge modules together with the plural guides. Thus, the cell cartridge modules are correctly seated on the pack bracket in a fixed state.

Ninth, the lattice-shaped ribs are formed at the central portion of the pack bracket such that the rigidity of the central portion to support the cell cartridge modules is increased. Accordingly, it is possible to prevent the central portion of the pack bracket from being damaged by the weight of the cell cartridge modules.

Tenth, the cell cartridge modules are spaced apart from each other by the spacing guide when they are seated on the pack bracket such that air may flow through the clearance defined between the cell cartridge modules. Accordingly, it is possible to dissipate heat generated from the cell cartridges in an air cooling manner.

Eleventh, the bridge brackets connect the cell cartridges respectively stacked on the uppermost layers of the cell cartridge modules such that the cell cartridge modules are fixed to be integrated into a single body. Accordingly, the cell cartridge modules seated on the pack bracket are connected such that they are integrated into a single body, to be firmly fixed. Thus, a sub-pack module, individual components of which are coupled, is completed. Accordingly, it is possible to achieve an enhancement in productivity. Also, the number of processing tasks required in manufacture of the sub-pack module is reduced.

Twelfth, the bridge brackets fix the cell cartridge modules while maintaining the clearance between the cell cartridge modules. Accordingly, the cell cartridges can be air-cooled by air flowing through the clearance.

Thirteenth, the bridge brackets couple the cell cartridge modules and bus bar module into an integrated body such that the entirety of the cell cartridge modules seated on the pack bracket and the bus bar module are firmly fixed, to cope with external impact or vibration.

Fourteenth, the high-voltage current transmitters are seated on the seats such that the seats protect the high-voltage current transmitters, to protect the high-voltage current transmitters from damage. Also, the portions of the high-voltage current transmitters connected to the bus bar module are prevented from being damaged due to exposure of the high-voltage current transmitters occurring when the operator manufactures the sub-pack module.

Fifteenth, the cell cartridge modules and bus bars form a sub-pack module, which is a single body, in a state in which the sensor assembly is coupled to the pack bracket. Accordingly, it is possible to easily produce a medium or large cell pack through stacking or connection of a plurality of sub-pack modules.

Sixteenth, the pack bracket is formed using a plastic material. Accordingly, it is possible to insulate current generated from the high-voltage current transmitters and/or bus bar module.

Effects of the present invention are not limited to the above-described effects. Other effects not described can be clearly understood by those skilled in the art from the description of the claims.

### DESCRIPTION OF DRAWINGS

The above and other objects, features and other advantages of the present invention will be more clearly understood from the following detailed description taken in conjunction with the accompanying drawings, in which:

FIG. 1 is a perspective view illustrating a battery according to an embodiment of the present invention;

FIG. 2 is an exploded perspective view of the battery according to the embodiment of the present invention;

FIG. 3 is a view illustrating a cell cartridge according to an embodiment of the present invention in a state in which a case is removed from the cell cartridge;

FIG. 4 is a sectional view of a cooling plate according to an embodiment of the present invention;

FIG. 5 is an exploded perspective view of a cell cartridge according to another embodiment of the present invention;

FIGS. 6 to 9 are views illustrating unit cells of a cell cartridge according to another embodiment of the present invention;

FIG. 10 is an exploded perspective view of a battery according to another embodiment of the present invention;

FIG. 11 is a view illustrating an assembled state of the battery;

FIG. 12 is a rear perspective view of the battery shown in FIG. 11; and

FIG. 13 is a sectional view illustrating a part where one long bolt is fastened.

### BEST MODE

Referring to embodiments of the present invention described hereinafter in detail with reference to the accompanying drawings, advantages and features of the present invention and methods for accomplishing the same will be clarified. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

Hereinafter, the present invention will be described with reference to the drawings for explaining vehicles according to embodiments of the present invention.

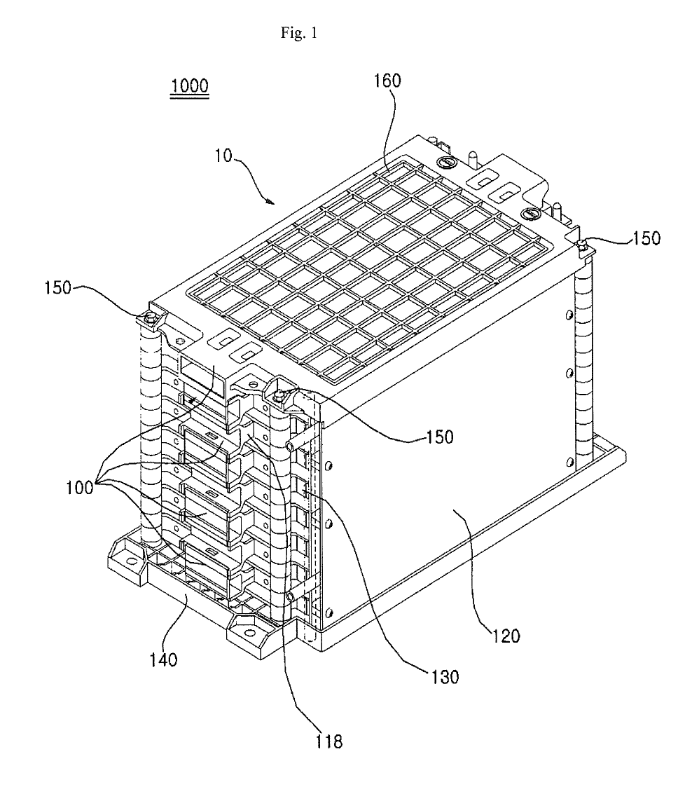

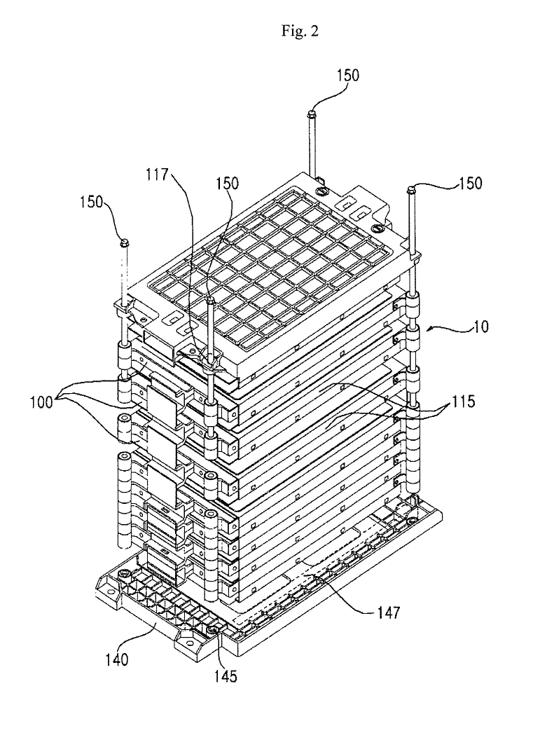

FIG. 1 is a perspective view illustrating a battery 1000 according to an embodiment of the present invention. FIG. 2 is an exploded perspective view of the battery 1000 according to the embodiment of the present invention.

Referring to FIGS. 1 and 2, the battery 100 according to the embodiment of the present invention includes a cell cartridge module 10 formed by stacking a plurality of cell cartridges 100, each of which generates current and is formed with a plurality of through holes 117 at corners thereof, a pack bracket 140 for supporting the cell cartridge module 10, to enable stacking of the cell cartridge module 10, and a plurality of long bolts 150 inserted into the through holes 117, to extend through the cell cartridges 100, and thus to fasten the cell cartridge module 10 to the pack bracket 140.

The cell cartridge module 10 is an assembly of cell cartridges 100. Current generated from each cell cartridge 100 functions as current to drive a vehicle. The cell cartridges 100 are stacked in plural to form one cell cartridge module 10.

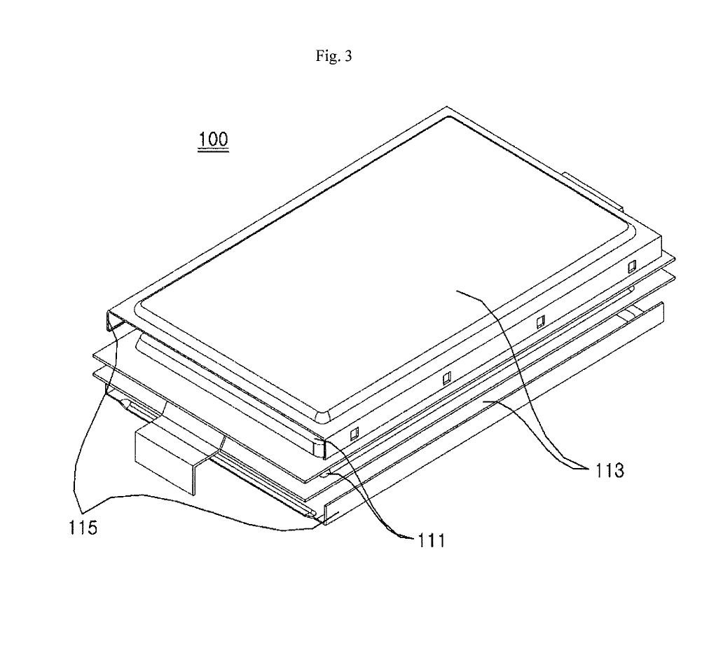

Each cell cartridge 100 is constituted by a plurality of unit cells 111 for generating current, and a case 118 for accommodating a plurality of unit cells 111. The case 118 is defined therein with an accommodation space, and may be formed with through holes 117 at sides thereof, as will be described later. Although not shown in FIGS. 1 and 2, a plurality of unit cells 111 is accommodated in the case 118. The unit cells 111 will be described later in conjunction with FIG. 3.

The cell cartridge module 10 is formed by stacking cell cartridges 100. Each cell cartridge 100 is formed with a through hole 117 at one side thereof. In detail, the through hole 117 may be formed at a corner or edge of the cell cartridge 100. Each cell cartridge 100 may be formed with a plurality of through holes 117. When the cell cartridges 100 are stacked to form the cell cartridge module 10, the through holes 117 of the cell cartridges 100 are coaxially aligned.

The pack bracket 140 forms an outer appearance of the battery 1000. The pack bracket 140 supports the cell cartridge module 10 beneath the cell cartridge module 10, to enable stacking of the cell cartridge module 10. A pack bracket cover 160 is provided at the top of the stacked cell cartridge module 10 in accordance with the illustrated embodiment, to complete one battery.

Long bolts 150 are inserted into the through holes 117, to extend through the cell cartridges 100. The long bolts 150 extend through sets of the coaxially aligned through holes 117 of the cell cartridge 100, respectively, to fasten the cell cartridge module 10 to the pack bracket 140. The long bolts 150 include any fastening means capable of extending through the through holes 117, to fasten the cell cartridge module 10 such that the cell cartridge module 10 has an integrated structure.

The pack bracket 140 is formed with fastening portions 145 to fasten respective long bolts 150 extending through the through holes 117. In accordance with an embodiment, the fastening portions 145 have a shape corresponding to the shape of the long bolts 150, to fasten the long bolts 150. When the long bolts 150 are fastened to the fastening portions 145, respectively, the cell cartridge module 10, through which the long bolts 150 extend, is fastened to the pack bracket 140 such that the cell cartridge module 10 has an integrated structure. Thus, handling or replacement of the cell cartridge module 10 becomes easy.

A cooling plate is provided at one side of the cell cartridge module 10, to absorb heat transferred from the cell cartridge module 10. The cooling plate 120 absorbs heat transferred from the stacked plural cell cartridges 100. Cooling water flows through the cooling plate 120, to outwardly dissipate heat transferred from the cell cartridges 100. Since the cooling water functions to outwardly dissipate heat, the heat of the cell cartridges 100 can be dissipated. Accordingly, it may be possible to prevent the lifespan of the cell cartridges 100 from being reduced due to the heat generated from the cell cartridge 100.

The pack bracket 140 is formed with a cooling plate seating portion 147 for seating of the cooling plate 120. The cooling plate seating portion 147 is formed at one side of the pack bracket 140, to allow the cooling plate 120 to be disposed at one side of the cell cartridge module 10.

A thermal pad 130, which transfers heat to the cooling plate 120, is in contact with the cooling plate seating portion 147. The thermal pad 130 is also in contact with heat transfer portions 115 of heat sink plates 113, which will be described later.

The thermal pad 130 contacts the heat transfer portions 115. The heat transfer portions 115 are formed at sides of the heat sink plates 113, which will be described later. The heat transfer portions 115 may be made of a material having superior thermal conductivity while having a planar shape, to transfer heat to the cooling plate 120 via the thermal pad 130. Coupling of the thermal pad 130 will be described later.

Heat transfer between the cell cartridge module 10 and the cooling plate 120 may be carried out through the thermal pad 130. The cooling plate 120 is fastened to the cell cartridge module 10 by bolts. The thermal pad 130 is pressed between the heat transfer portions 115 and the cooling plate 120. In accordance with the pressing, more efficient heat transfer may be achieved.

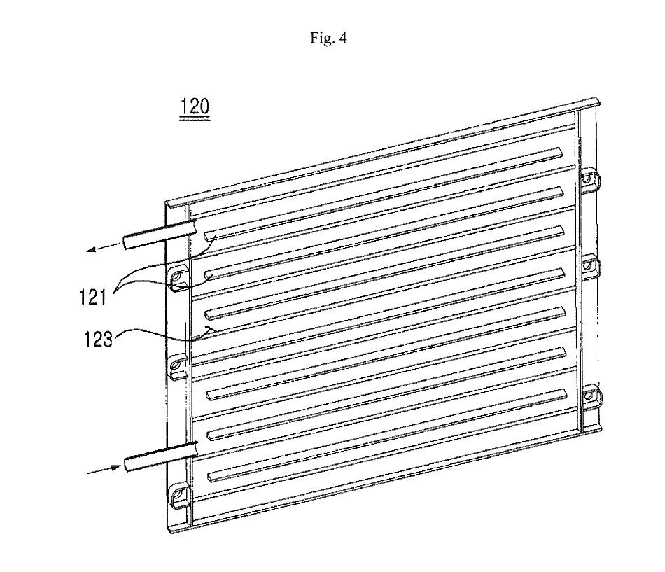

In accordance with an embodiment, heat transfer may be carried out through direct contact between the cell cartridge module 10 and the cooling plate 120 without using the thermal pad 130. A detailed configuration of the cooling plate 120 will be described later in conjunction with FIG. 4.

FIG. 3 is a view illustrating the cell cartridge 100 according to the illustrated embodiment of the present invention in a state in which the case 118 is removed from the cell cartridge 100.

Referring to FIG. 3, the cell cartridge 100 according to the illustrated embodiment of the present invention includes a plurality of unit cells 111 to discharge current, and the heat sink plates 113 to transfer heat generated from the unit cells 111.

Each unit cell 111 is a minimum unit to supply current. Each unit cell 111 includes a chargeable and dischargeable secondary cell or fuel cell, which generates current. A plurality of unit cells 111 may have a stacked structure.

The plural unit cells 111 send current to an electrode formed at one side of the plural unit cells 111. In a preferred embodiment, it is preferred that two unit cells 111 be stacked, even though embodiments of the present invention are not limited thereto.

The heat sink plates 113 receive heat generated from the unit cells 111. Preferably, the heat sink plates 113 are made of a metal material having thermal conductivity. The heat sink plates 113 may be made of aluminum or copper, even though embodiments of the present invention are not limited thereto.

The heat sink plates 113 are formed to enclose the unit cells 111, respectively. Each heat sink plate 113 is formed, at sides thereof, with the heat transfer portions 115, to transfer heat to the cooling plate 120. As the heat sink plates 113 enclose the unit cells 111, they may effectively absorb heat generated from the unit cells 111, and then effectively transfer the absorbed heat to the cooling plate 120.

The heat transfer portions 115, which are made of the same material as the heat sink plate 113, may be formed at sides of the heat sink plates 113, to have a bent structure. Each heat transfer portion 115 is formed to have a planar structure so that it may contact the thermal pad 130. The thermal pad 130 contacts the cooling plate 120, to transfer heat to the cooling plate 120. In accordance with an embodiment, heat transfer may be carried out through direct contact between the heat transfer portions 115 and the cooling plate 120 without using the thermal pad 130.

The heat sink plates 113 are provided at the top and bottom of the unit cells 111. The heat sink plates 113 are disposed at the top and bottom of the unit cells 111, respectively, to enclose the unit cells 111. Where two unit cells 111 are stacked in a preferred embodiment, the heat sink plate 113 disposed at the top receives heat from the upper unit cell 111, and the heat sink plate 113 disposed at the bottom receives heat from the lower unit cell 111.

The thermal pad 130 is provided between the heat sink plates 113 and the cooling plate 120, to transfer heat from the heat sink plates 113 to the cooling plate 120. The thermal pad 130 is provided between the cooling plate 120 shown in FIG. 1 and the cell cartridge module 10.

The thermal pad 130 contacts the cell cartridge module 10. The thermal pad 130 also contacts the heat transfer portions 115 of the heat sink plates 113 at one side of the thermal pad 130. The thermal pad 130 is disposed, at the other side thereof, on the cooling plate 120 so as to transfer heat received from the thermal transfer portions 115.

The thermal pad 130 may be made of a material having superior thermal conductivity while having a planar shape. In order to dispose the thermal pad 130 at one side of the cell cartridge module 10, the pack bracket 140 may be formed with a thermal pad seating portion (not shown) for seating of the thermal pad 130.

FIG. 4 is a sectional view of the cooling plate 120 according to the illustrated embodiment of the present invention.

Referring to FIG. 4, the cooling plate 120 is foamed with a hollow cavity 123. A plurality of ribs 121 is formed in the cavity 123, to define a flow passage.

The hollow cavity 123 is formed in the cooling plate 120, to allow cooling water to flow therein. Cooling water supplied from the outside of the cooling plate 120 is introduced into the cavity 123 inside the cooling plate 120 receives heat transferred from the cell cartridge 100. Thereafter, the cooling water is discharged to the outside, and is then again cooled to a predetermined temperature through heat exchange. Subsequently, the cooling water returns to the cooling plate 120.

The plural ribs 121, which define a flow passage, are formed in the cavity 123 of the cooling plate 120. Through the flow passage, cooling water flows within the cooling plate 120. The plural ribs 121 protrude to define the flow passage. The flow passage, which is defined by the ribs 121 to allow cooling water to flow therethrough, may have various shapes. The ribs 121 increase the inner surface area of the cooling plate 120, to achieve more effective heat exchange between the cooling plate 120 and the cooling water. The plural ribs 121 support the cooling plate 120 in a transverse direction in order to enhance the durability of the cooling plate 120 in the transverse direction. The plural ribs 121 cause the cooling water to form vortices in the cavity 123 so as to achieve more effective heat exchange.

The cooling plate 120 is formed such that cooling water, which transfers, to the outside of the cooling plate 120, heat transferred to the cooling plate 120, passes through the cooling plate 120. Flow of the cooling water may be achieved by forming a flow passage using the above-described ribs 121. In accordance with another embodiment, it may be possible to pass cooling water through the cooling plate 120 by forming partitions in the hollow cavity 123 of the cooling plate 120. In this case, cooling water passes through compartments defined by the partitions, to cool the cooling plate 120. Also, the cooling plate 120 may include only the cavity 123, through which cooling water passes. Of course, embodiments of the present invention are not limited to the above-described embodiments.

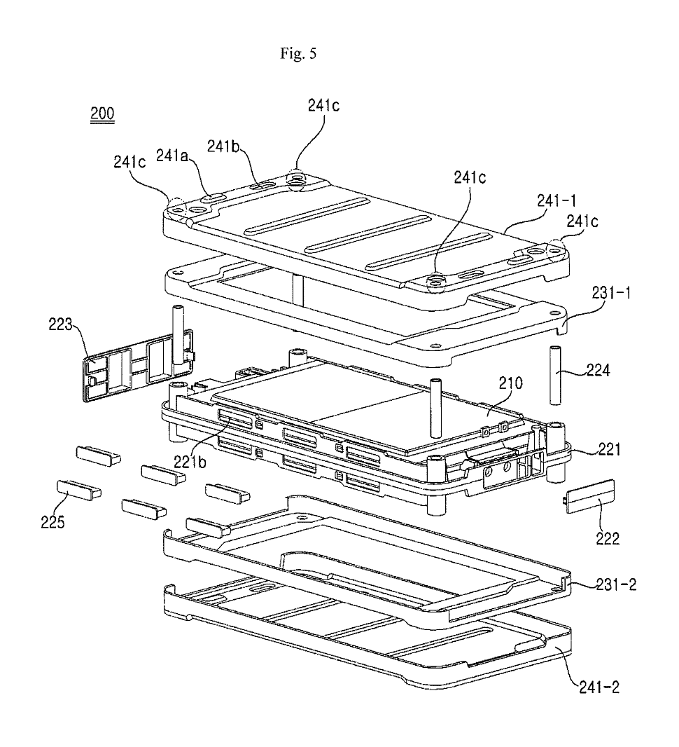

FIG. 5 is an exploded perspective view of a cell cartridge 200 according to another embodiment of the present invention.

Referring to FIG. 5, the cell cartridge 200 according to the illustrated embodiment of the present invention includes a plurality of unit cells 220, an upper cartridge member 231-1, a lower cartridge member 231-2, a central cartridge member 221, and a cover 241-1/241-2.

Each of the plural unit cells 220 is a bundle of unit cells. Each unit cell is a nickel metal hydride (Ni-MH) cell or a lithium ion cell, which generates current. The plural unit cells 220 are disposed in the central cartridge member 221. The upper cartridge member 231-1 closely contacts the peripheral edge of the top of the plural unit cells 220. The upper cover 241-1, which will be described later, closely contacts the inner portion of the top of the plural unit cells 220. The lower cartridge member 231-2 closely contacts the peripheral edge of the bottom of the plural unit cells 220. The lower cover 241-2, which will be described later, closely contacts the inner portion of the bottom of the plural unit cells 220.

The cover 241-1/241-2 may include the upper cover 241-1 and/or the lower cover 241-2. The upper cover 241-1 is disposed at the top of the cell cartridge 200, and the lower cover 241 is disposed at the bottom of the cell cartridge 200.

The upper cover 241-1 contacts the top of the plural unit cells 220, to dissipate heat generated from the plural unit cells 220. Preferably, the upper cover 241-1 is made of aluminum having superior heat dissipation ability. The upper cartridge member 231-1 is disposed between the upper cover 241-1 and the plural unit cells 220.

The upper cartridge member 231-1 contacts the top edge of the plural unit cells 220. The upper cartridge member 231-1 prevents the top edge of the plural unit cells 220 from coming into direct contact with the upper cover 241-1, to provide insulation. The upper cartridge member 231-1 supports the top edge of the plural unit cells 220 between the plural unit cells 220 and the upper cover 241-1, to protect the top edge of the plural unit cells 220.

The lower cover 241-2 is formed to have the same structure as the upper cover 241-1. When the upper cover 241-1 is coupled to the bottom of the cell cartridge 200, it becomes the lower cover 241-2. Since the upper cover 241-1 and lower cover 241-2 have the same structure, the cell cartridge 200 has a constant outer structure. Also, it is unnecessary to manufacture the upper cover 241-1 and lower cover 241-2 in a separate manner. As a result, it may be possible to reduce manufacturing costs and to achieve easy and convenient management.

Description of the lower cover 241-2 and lower cartridge member 231-2 is identical to the description of the upper cover 241-1 and upper cartridge member 231-1. Accordingly, no detailed description will be given of the lower cover 241-2 and lower cartridge member 231-2.

Each of the upper cover 241-1 and lower cover 241-2 is formed with convex portions 241a protruded from an outer surface of the cover, and concave portions 241b recessed from the outer surface of the cover. When cell cartridges 200 are stacked, coupling between the convex portions 241a and the concave portions 241b is achieved between the stacked cell cartridges 200, to provide alignment of the stacked cell cartridges 200. The convex portions 241a and concave portions 241b are symmetrically formed at four corners of the top of the upper cover 241-1. Accordingly, it may be possible to achieve normal stacking, in which cell cartridges 200 are stacked in the same direction, and inverted stacking, in which cell cartridges 200 are stacked in an inverted manner.

That is, the upper cover 241-1 and lower cover 241-2 are formed to have the same structure. Also, the convex portions 241a and concave portions 241b of the upper cover 241-1 and lower cover 241-2 are formed at corresponding positions at which the convex portions 241a and concave portions 241b are coupled when the upper cover 241-1 and lower cover 241-2 face each other. Since the convex portions 241a and concave portions 241b of the upper cover 241-1 and lower cover 241-2 are formed at corresponding positions, they guide the cell cartridges 200 to set the coupling positions of cell cartridges 200 during stacking of the cell cartridges 200 carried out in such a manner that the lower cover 241-2 of the uppermost one of the cell cartridges 220 is coupled with the upper cover 241-1 of the cell cartridge 200 stacked just beneath the uppermost cell cartridge 200.

Each of the upper cover 241-1 and lower cover 241-2 is formed with through holes 241c, through which long bolts 400 pass when cell cartridges 200 are coupled in a stacked manner. When the upper cover 241-1 and lower cover 241-2 are coupled to the central cartridge member 221, the through holes 241c of the upper cover 241-1 and lower cover 241-2 are aligned to form passages.

The plural unit cells 220 are disposed in the central cartridge member 221. The upper cover 241-1 is coupled to the top of the central cartridge member 221 such that the upper cartridge member 231-1 is interposed between the upper cover 241-1 and the central cartridge member 221. The lower cover 241-2 is coupled to the bottom of the central cartridge member 221 such that the lower cartridge member 231-2 is interposed between the lower cover 241-2 and the central cartridge member 221. For coupling, various coupling methods such as bonding, bolt fastening, and welding may be used.

Spacers 224 are provided at the central cartridge member 221. The spacers 224 support the upper cartridge member 231-1, upper cover 241-1, lower cartridge member 231-2 and lower cover 241-2. When cell cartridges 200 are coupled in a stacked manner, the long bolts 400, which will be described later, pass through the spacers 224.

Side holes 221b are formed at the central cartridge member 221. Cartridge supports 225 are inserted into the side holes 221b, respectively. The cartridge supports 225 support the edges of the plural unit cells 220 between adjacent ones of the unit cells 220, to protect the edges of the unit cells 220.

A front cover 223 is coupled to a front surface of the central cartridge member 221. A rear cover 222 is also coupled to a rear surface of the central cartridge member 221. Thus, the front cover 223 and rear cover 222 protect terminals of the plural unit cells 220.

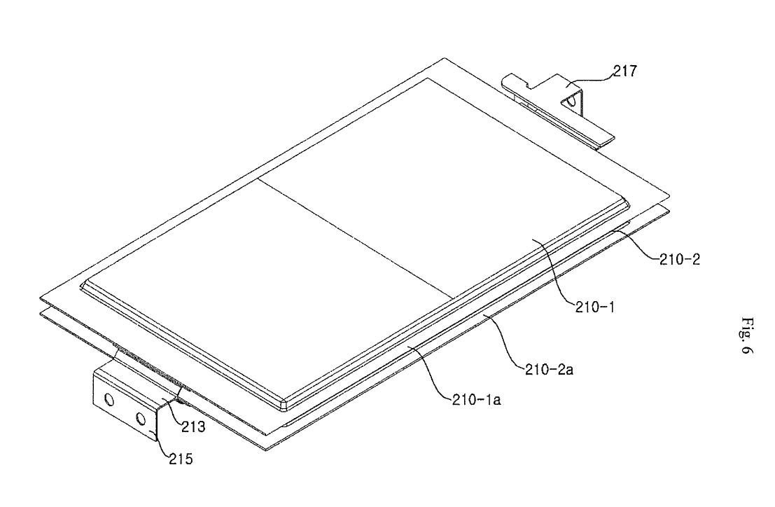

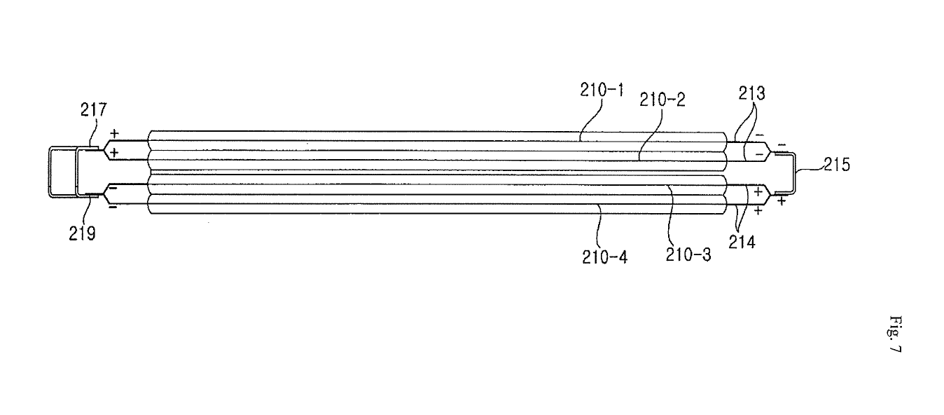

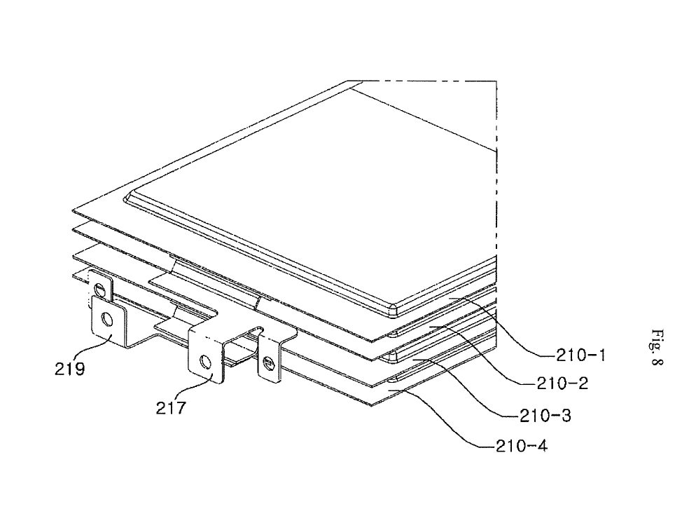

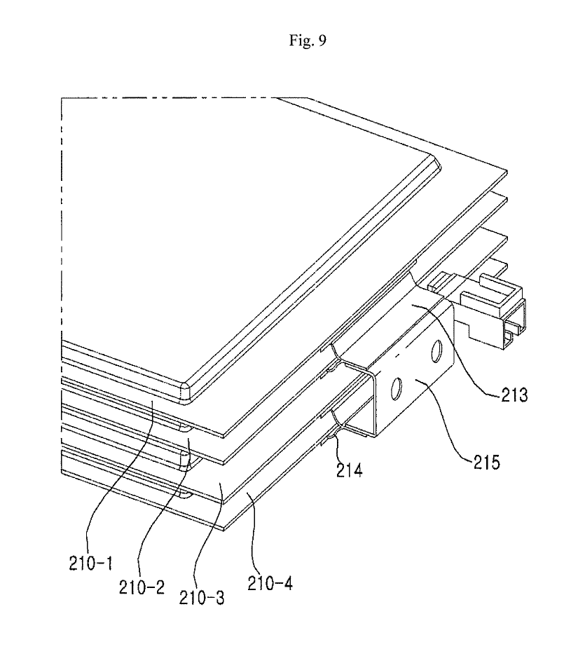

FIGS. 6 to 9 are views illustrating unit cells of a cell cartridge 200 according to another embodiment of the present invention.

Referring to FIGS. 6 to 9, the plural unit cells 220 preferably include four unit cells, namely, first to fourth unit cells 220-1 to 220-4. Of course, the number of unit cells may be varied in accordance with the structure of the unit cells.

The first unit cell 220-1 and second unit cell 220-2 are coupled in a close contact state, and the third unit cell 220-3 and fourth unit cell 220-4 are coupled in a close contact state. A gap is formed between the second unit cell 220-2 and the third unit cell 220-3. The gap between the second unit cell 220-2 and the third unit cell 220-3 is defined by the central cartridge member 221. Since there is a gap between the second unit cell 220-2 and the third unit cell 220-3, it may be possible to cope with expansion of the unit cells during charge and discharge. A thermal sensor (not shown) may be disposed in the gap between the second unit cell 220-2 and the third unit cell 220-3.

A first unit cell sealing portion 220-1a is provided at the first unit cell 220-1, as a portion for sealing the edge of the first unit cell 220-1. When the first unit cell sealing portion 220-1a is torn or broken, a cell solution may leak, thereby causing electrical conduction. Accordingly, the first unit cell sealing portion 220-1a closely contacts the upper cartridge member 231-1 in order to secure insulation and protection of the first unit cell sealing portion 220-1a.

A cartridge support 225 is inserted between the first unit cell sealing portion 220-1a and a second unit cell sealing portion 220-2a, to support the sealing portions while protecting and insulating the sealing portions. In particular, the cartridge support 225 prevents electrical conduction caused by cell solution leakage due to partial tearing or breakage of the first unit cell sealing portion 220-1a and a second unit cell sealing portion 220-2a occurring due to vibration of a vehicle in a state in which the first unit cell sealing portion 220-1a and a second unit cell sealing portion 220-2a contact the upper cartridge member 231-1 due to loosening thereof caused by weights thereof when the cell cartridge 200 is in the upright position.

The plural unit cells 220 are provided with a parallel positive electrode terminal 217, a parallel negative electrode terminal 219, parallel negative electrodes 213, parallel positive electrodes 214, and a serial electrode 215.

The parallel positive electrode terminal 217 connects the first unit cell 220-1 and second unit cell 220-2 in parallel, to form an anode of the plural unit cells 220. The parallel positive electrode terminal 217 is disposed at one side of the plural unit cells 220. The parallel negative electrode terminal 219 connects the third unit cell 220-3 and fourth unit cell 220-4 in parallel, to form a cathode of the plural unit cells 220. The parallel negative electrode terminal 219 is disposed at one side of the plural unit cells 220 in parallel with the parallel positive electrode terminal 217.

The parallel negative electrodes 213 connect the first unit cell 220-1 and second unit cell 220-2 in parallel. The parallel positive electrodes 214 connect the third unit cell 220-3 and fourth unit cell 220-4 in parallel. The serial electrode 215 connects the parallel negative electrodes 213 and parallel positive electrodes 214.

The first unit cell 220-1 and second unit cell 220-2 are connected in parallel, and the third unit cell 220-3 and fourth unit cell 220-4 are connected in parallel. The two sets of parallel-connected unit cells are then connected in series. Thus, the plural unit cells 220 are connected to form a dual-parallel/dual-serial connection structure. Of course, the connection structure may be varied in accordance with a required voltage and a required capacity.

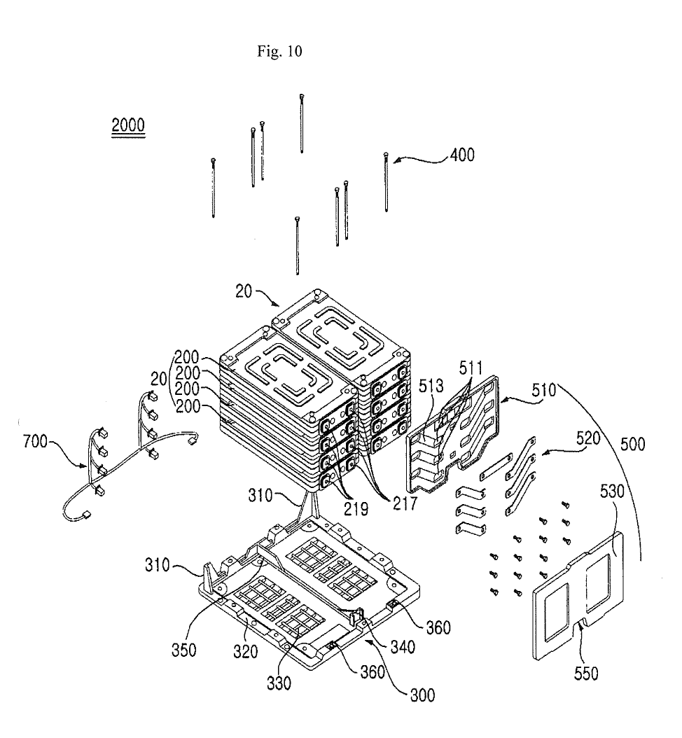

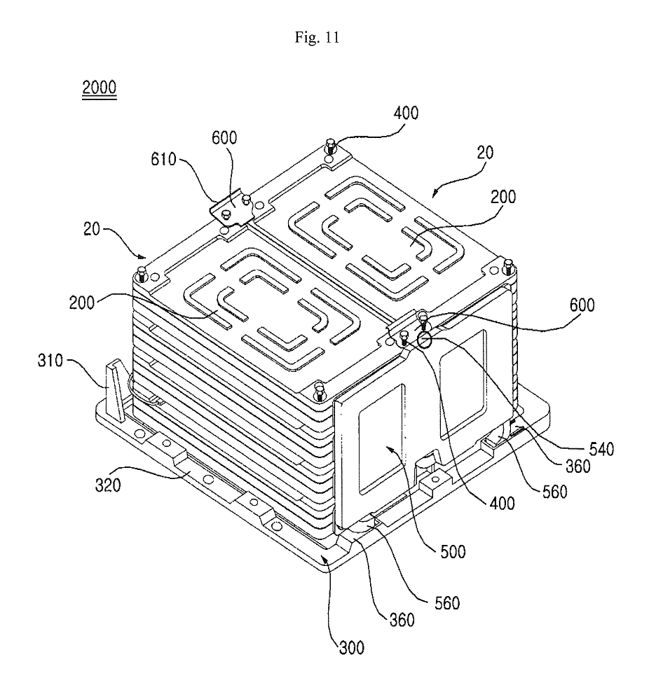

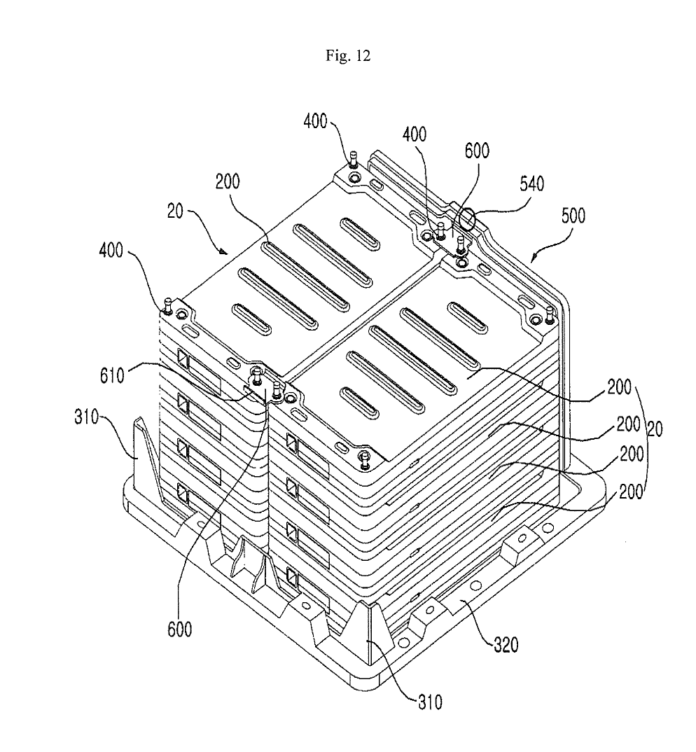

FIG. 10 is an exploded perspective view of a battery 2000 according to another embodiment of the present invention. FIG. 11 is a view illustrating an assembled state of the battery 2000 shown in FIG. 10. FIG. 12 is a rear perspective view of the battery 2000 shown in FIG. 11.

Referring to FIGS. 10 to 12, the battery 2000 according to the illustrated embodiment of the present invention includes a plurality of cell cartridges 200, each of which generates current, and is formed with a plurality of through holes 241c at corners thereof, a cell cartridge module 20 formed by stacking the plural cell cartridges 200, a bus bar module 500 disposed at one side of the cell cartridge module 20, to connect the cell cartridges 200, a pack bracket 300 coupled with the bus bar module 500, to provide a seat for the cell cartridge module 20, while being formed with a plurality of guides 320 to support the cell cartridge module 20, and a plurality of long bolts 400 inserted into the through holes 241c, to be fastened to the pack bracket 300 while extending through the cell cartridges 200.

Each cell cartridge 200 is constituted by a plurality of unit cells 220 for generating current, as described above. Each cell cartridge 200 includes an upper cover 241-1 and a lower cover 241-2, each of which is formed with a plurality of through holes 241c. Although the through holes 241c are preferably formed at the corners of the cell cartridge 200, the positions of the through holes 241c are not limited thereto.

The above-described parallel positive electrode terminal 217 and/or parallel negative electrode terminal 219 of each cell cartridge 200 are exposed at one side of the cell cartridge 200. The parallel positive electrode terminal 217 and/or parallel negative electrode terminal 219 are coupled with the bus bar module 500, which will be described later.

The cell cartridges 200 are stacked in plural to form one cell cartridge module 20. The cell cartridge module 20 may have a stacked structure in which the cell cartridges 20 are vertically and/or horizontally stacked. The cell cartridge module 20 is formed by stacking at least two cell cartridges 200. The description associated with FIG. 10 and the drawings following FIG. 10 will be given in conjunction with the case in which four cell cartridges 200 are stacked to form the cell cartridge module 20, but the number of cell cartridges 200 is not limited thereto.

The cell cartridge module 20 may include a plurality of cell cartridge modules, namely, at least two cell cartridge modules. In accordance with various embodiments, the cell cartridge modules may be vertically and/or horizontally arranged. The following description will be given in conjunction with the case in which two cell cartridge modules 20 are arranged in parallel on the same plane, but the arrangement of the cell cartridge modules 20 is not limited thereto.

The bus bar module 500 is coupled with the plural cell cartridge modules 20, to connect the cell cartridges 200. In detail, the bus bar module 500 includes bus bars 520 for electrically connecting the cell cartridges 200 forming the plural cell cartridge modules 20, a bus bar plate 520 formed with bus bar receiving grooves 513 for receiving the bus bars 520, respectively, and a plate cover 530 coupled with the bus bar plate 520, to shield the bus bars 513 received in the bus bar receiving grooves 513.

One main surface of the bus bar plate 520 contacts the plural cell cartridge modules 20. The bus bar plate 520 is formed with a plurality of terminal openings 511, each of which allows the corresponding bus bar 520 to contact the parallel positive electrode terminal 217 and/or parallel negative electrode terminal 219 provided at the corresponding cell cartridges 200. The parallel positive electrode terminal 217 and/or parallel negative electrode terminal 219 are fitted in the corresponding terminal openings 511. As each bus bar 520 contacts the corresponding parallel positive electrode terminal 217 and/or parallel negative electrode terminal 219, the cell cartridges 200 are connected in parallel and/or in series. The bus bar plate 520 may be made of an insulating material in order to avoid electrical short circuit of the cell cartridges 200.

The bus bar receiving grooves 513 may be formed on at lest one of the bus bar plate 520 or plate cover 530. The following description will be given in conjunction with the case in which the bus bar receiving grooves 513 are formed on the bus bar plate 520. In another embodiment, the bus bar receiving grooves 513 may be formed on the plate cover 530. The bus bar receiving grooves 513 are recessed to receive the bus bars 520, respectively. The bus bar receiving grooves 513 also have a shape corresponding to the shape of the bus bars 520.

The bus bars 520 are received in the bus bar receiving grooves 513 in a fixed state, respectively. Each bus bar 520 contacts the parallel positive electrode terminal 217 and/or parallel negative electrode terminal 219 fitted in the corresponding terminal openings 11 of the bus bar plate 520, to connect the corresponding cell cartridges 200 in parallel and/or in series.

The plate cover 530 is formed to correspond to the bus bar plate 520. The plate cover 530 shields the bus bars 520 such that the bus bars 520 are prevented from being outwardly exposed. The plate cover 530 shields the bus bars 520 together with the bus bar plate 520 such that the bus bars 520, through which current flows, are prevented from being outwardly exposed. Also, the plate cover 530 is made of an insulating material in order to prevent the operator from being affected by current flowing through the bus bars 520.

The pack bracket 300 is coupled with the bus bar module 500. In detail, a coupling protrusion 340 protruded from one side of the pack bracket 300 is coupled with a coupling groove 550 recessed from one side of the bus bar module 500 such that the pack bracket 300 and bus bar module 500 are coupled. The coupling groove 550 is formed at one side of the bus bar module 500, and the coupling protrusion 340 is formed at a position corresponding to the position where the coupling groove 550 is formed. For coupling of the coupling groove 550 to the coupling protrusion 340, various methods such as welding, bonding, adhesion, and fastening using fastening means may be used.

The plural cell cartridge modules 20 are seated on the pack bracket 300. A plurality of guides 320 is formed in a protruded state at the pack bracket 300, to support the cell cartridge modules. The plural guides 320 may be formed along the periphery of the pack bracket 300. The following description will be given in conjunction with the case in which the plural guides 320 are formed at corner portions of the periphery of the pack bracket 300, but the formation positions of the guides 320 are not limited thereto.

The pack bracket 330 is formed using a plastic material. The pack bracket 330 uses a plastic material to easily form a shape of the pack bracket 330 corresponding to the shape of the cell cartridge modules 20 during manufacture of the pack bracket 330, for seating of the cell cartridge modules 20 on the pack bracket 300.

The guides 320 are formed at corresponding corner portions of the pack bracket 300, to support corresponding corner portions of the cell cartridge modules 20 seated on the pack bracket 300, respectively. The guides 320 may be formed to be bent such that they surround the corresponding corner portions of the cell cartridge modules 20, respectively. As the plural guides 320 support the corresponding corner portions of the cell cartridge modules 20, respectively, the cell cartridge modules 20 seated on the pack bracket 300 are firmly supported by the guides 320.

Since the plural guides 320 support the cell cartridge modules 20, as described above, it may be possible to prevent each cell cartridge module 20 from being damaged by external impact or vibration.

The pack bracket 300 may be divided into a central portion 330, on which the cell cartridge modules 20 are seated in a contact state, and a peripheral portion 320 extending along a periphery of the central portion 330. The cell cartridge modules 20 are not seated on the peripheral portion 320. The plural guides 320 may be formed at the peripheral portion 320.

The peripheral portion 320 is formed to be protruded farther than the central portion 330. Accordingly, when the cell cartridge modules 20 are seated on the central portion 330, the peripheral portions of the cell cartridge modules 20 come into contact with an inner surface of the peripheral portion 320, to support the cell cartridge modules 20. The peripheral portion 320 is upwardly protruded farther than the central portion 33 with reference to the ground. Accordingly, when the cell cartridge modules 20 are seated on the central portion 330, the peripheral portion 320 uniformly shields the peripheral portions of the cell cartridges 200. As the peripheral portion 320 contacts the peripheral portions of the cell cartridge modules 20 along the inner surface of the peripheral portion 320, it supports the peripheral portions of the cell cartridge modules 20 together with the plural guides 320. Thus, the cell cartridge modules 20 are correctly seated on the pack bracket 300 in a fixed state.

Lattice-shaped ribs are formed at the central portion 330, to increase the rigidity of the central portion 330 to support the cell cartridge modules 20 when the cell cartridge modules 20 are seated on the central portion 330. Since the central portion 330 is a portion to support the cell cartridge modules 20, which are heavy, when the cell cartridge modules 20 are seated, the central portion 330 requires high rigidity to support the cell cartridge modules 20. For such high rigidity, the central portion 330 is formed with the lattice-shaped ribs.

The lattice-shaped ribs may be formed at a part of the central portion 330 on which the cell cartridges 200 are seated. The ribs are formed such that the level of support points of the ribs, at which the ribs support the cell cartridge module 20, is flush with the level of the central portion 330. In this case, the rib-formed part is formed to be recessed with reference to the plane of the central portion 330.

As the lattice-shaped ribs are formed at the central portion 330, the rigidity of the central portion 330 to support the cell cartridge modules 20 is increased. Accordingly, it is possible to prevent the central portion 330 of the pack bracket 300 from being damaged by the weight of the cell cartridge modules 20.

A spacing guide 350 is centrally formed at the pack bracket 300 in a protruded state. When it is assumed that the area between the two cell cartridge modules 20 seated on the pack bracket 300 in a state of being arranged on the same plane is a center line of the pack bracket 300, the spacing guide 350 is formed on the center line in a protruded state. The spacing guide 350 divides the positions where respective cartridge modules 20 are seated. The spacing guide 350 is disposed between the cell cartridge modules 20, to space the cell cartridge modules 20 from each other.

As the cell cartridge modules 20 are spaced apart from each other by the spacing guide 350, air may flow through a clearance defined between the cell cartridge modules 20. Accordingly, it may be possible to dissipate heat generated from the cell cartridges 200 in an air cooling manner.

The long bolts 400 are inserted into the through holes 241c. When the cell cartridges 200, through which the through holes 241c are formed, are stacked to form one cell cartridge module 20, the through holes 241c formed through the cell cartridges 200 are aligned to allow the long bolts 400 to extend therethrough. As the long bolts 400 pass through the through holes 241c of the cell cartridges 200, they extend through the entirety of the plural cell cartridges 200. In this case, the long bolts 400 may extend through the spacers 224 provided in the cell cartridges 200. Each long bolt 400 is formed to have a length capable of completely extending through one cell cartridge module 20. Thus, it may be possible to fasten the cell cartridge modules 20 to the pack bracket 300.

In a state in which the cell cartridge modules 20 are fastened to the pack bracket 300 by the long bolts 400, the bus bar module 500 provided at the cell cartridge modules 20 is coupled with the pack bracket 300. Accordingly, the battery 2000, individual components of which are firmly coupled, is completed. Thus, it may be possible to manufacture a single module for constituting a medium or large cell pack, in a simple and convenient manner in terms of structure, while reducing the number of processing tasks.

Bridge brackets 600 may further be provided between the cell cartridges 200 respectively stacked on the uppermost layers of the cell cartridge modules 20 arranged on the same plane, to fix the cell cartridges 200. One side portion of each bridge bracket 600 is coupled to the cell cartridge 200 stacked on the uppermost layer of one cell cartridge module 20. The other side portion of each bridge bracket 600 is coupled to the cell cartridge 200 stacked on the uppermost layer of the other cell cartridge module 20. Here, the “uppermost layer” means the layer, on which the cell cartridge 200 spaced farthest from the pack bracket 300 contacting the cell cartridge 200 stacked on the lowermost layer of the cell cartridge module 20 is stacked.

Each bridge bracket 600 is connected with the cell cartridges 200 respectively stacked on the uppermost layers of the cell cartridge modules 200. The bridge bracket 600 fixes the cell cartridges 200 stacked on the uppermost layers such that the cell cartridges 200 are integrated into a single body. Thus, the cell cartridge modules 20 are fixed to be integrated into a single body.

Each bridge bracket 600 is formed with openings (not shown), which are aligned with the corresponding through holes 241c formed through the cell cartridges 200 when the bridge bracket 600 is coupled to the cell cartridges 200. In a state in which the openings are aligned with the through holes 241c, the long bolts 400 extend through the aligned openings and through holes 241c, to be fastened to the pack bracket 300.

As one long bolt 400 is fastened in a state in which the opening formed at one side of the bridge bracket 600 is aligned with the through hole 241c formed through the cell cartridge 200 stacked on the uppermost layer of one cell cartridge module 20, the cell cartridge module 20 is fixed to the pack bracket 300 in a seated state. Also, as another long bolt 400 is fastened in a state in which the opening formed at the other side of the bridge bracket 600 is aligned with the through hole 241c formed through the cell cartridge 200 stacked on the uppermost layer of the other cell cartridge module 20, the other cell cartridge module 20 is fixed to the pack bracket 300 in a seated state.

As the bridge brackets 600 connect the two cell cartridge modules 20 such that the cell cartridge modules 20 are integrated into a single body, the cell cartridge modules 20 seated on the pack bracket 300 are connected such that they are integrated into a single body, to be firmly fixed. Thus, the battery 200, in which individual components thereof are coupled, is completed. Accordingly, it may be possible to achieve an enhancement in productivity. Also, the number of processing tasks required to manufacture the battery 2000 is reduced.

Also, the bridge brackets 600 fix the cell cartridge modules 20 while maintaining the clearance between the cell cartridge modules 20. Accordingly, the cell cartridges 200 can be air-cooled by air flowing through the clearance.

A lug 540 is protruded from one side of the bus bar module 500, to be coupled with one bridge bracket 600. The lug 540 is coupled with one bridge bracket 600, to fix the bus bar module 500 and bridge bracket 600.

Each bridge bracket 600 is formed, at one side thereof, with a hook 620 having a bent structure. The lug 540 may be formed to have a recessed hook receiving portion (not shown) so as to receive the hook 620, for engagement thereof with the hook 620.

In a state in which the bridge brackets 600 are coupled with the cell cartridges 200 stacked on the uppermost layers of the cell cartridge modules 20 arranged on the same plane such that the cell cartridge modules 20 are coupled to be integrated into a single body, one of the bridge brackets 600 is coupled with the lug 540 of the bus bar module 500. That is, the hook 620 of the bridge bracket 600 is engaged with the lug 540 of the bus bar module 500. Thus, the cell cartridge modules 20 integrated into a single body are coupled with the bus bar module 500.

As the bridge brackets 600 couple the cell cartridge modules 20 and bus bar module 500 into an integrated body, the entirety of the cell cartridge modules 20 seated on the pack bracket 300 and the bus bar module 500 are firmly fixed such that they can cope with external impact or vibration.

The bus bar module 500 is further provided with a high-voltage current transmitter 560 for externally transmitting current generated from the cell cartridge modules 20. The high-voltage current transmitter 560 is a part for externally transmitting current generated from the cell cartridges 200 through one cathode and one anode, which are coupled to the current by a plurality of bus bars 520. The high-voltage current transmitter 560 is included in the bus bar module 500. The bus bar module 500 may include a plurality of high-voltage current transmitters, which form a cathode and an anode, respectively. The illustrated embodiment of the present invention is described in conjunction with the case in which there are two high-voltage current transmitters 560 between the bus bar module 500 and the pack bracket 300, but the concept of the present invention is not limited thereto.

Seats 360 are formed in a recessed state at one side of the pack bracket 300, for seating of the high-voltage current transmitters 560. The seats 360 are formed at one side of the peripheral portion 320 of the pack bracket 300 such that the number thereof corresponds to the number of the high-voltage current transmitters 560. The high-voltage current transmitters 560 are seated on the seats 360, respectively, such that they are protected by the seats 360 so as not to be damaged.

Since the high-voltage current transmitters 560 are seated on the seats 360, portions of the high-voltage current transmitters 560 connected to the bus bar module 500 are prevented from being damaged due to exposure of the high-voltage current transmitters 560 occurring when the operator manufactures the battery 2000.

Also, since the pack bracket 300 is formed using a plastic material, it may be possible to insulate current generated from the high-voltage current transmitters 560 and/or bus bar module 500.

The pack bracket 300 is further provided with a sensor assembly 700 coupled to the cell cartridge modules 20, to measure the current and temperature of the cell cartridges 299. The sensor assembly 700 includes connectors (not shown) respectively coupled to the cell cartridges 200 constituting each cell cartridge module 20. Thus, a group of connectors is connected to one cell cartridge module 20. The sensor assembly 700 measures the current and temperature of each cell cartridge 200, and externally transmits data obtained through measurement, to enable detection of abnormality, overheating, etc. of the cell cartridge 200.

The sensor assembly 700 is coupled to the pack bracket 300 after having been coupled to the cell cartridge modules 20. Coupling holes (not shown) may be formed at the pack bracket 330, to enable the sensor assembly 700 to be coupled to the pack bracket 300. Also, coupling members (not shown) may be provided at the sensor assembly 700, to be coupled with the coupling holes, respectively. As the coupling members are coupled with the coupling holes by coupling means, the sensor assembly 700 is coupled to the pack bracket 300. Thus, the sensor assembly 700 is prevented from being separated from the cell cartridges 200.

Thus, the cell cartridge modules 20 and bus bars 520 form the battery 2000, which is a single body, in a state in which the sensor assembly 700 is coupled to the pack bracket 300. Accordingly, it may be possible to easily produce a medium or large cell pack through stacking or connection of a plurality of batteries 2000.

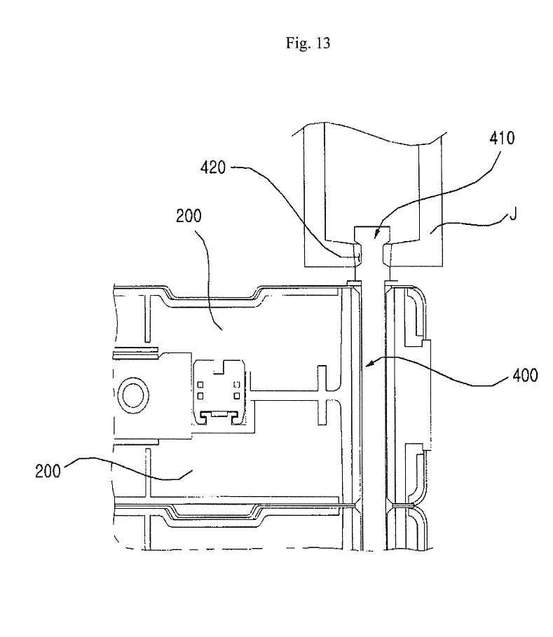

FIG. 13 is a sectional view illustrating a part where one long bolt 400 is fastened.

Referring to FIG. 13, each long bolt 400 includes a head 420, and a groove 420 formed around the head 420 in a recessed state. The head 420, which is a portion of the long bolt 400 exposed without being inserted into the through holes 241c, through which the long bolt 400 extends, is exposed outwardly of the corresponding cell cartridge module 20. The groove 420 is formed around the head 420 in a recessed state. The groove 420 may be uniformly inwardly recessed around the head 420.

A feeding jig J may be engaged with the groove 420. The feeding jig J is engaged with the groove 420 formed at the head 420 of the long bolt 400 when the battery 2000 is fed in a state of being completely assembled in accordance with fastening of the long bolt 400. The groove 420 formed at the head 420 may have a shape corresponding to the shape of the feeding jig J. When the completely-assembled battery 2000 is fed, it may be possible to easily achieve the feeding operation using the feeding jig J engaged with the groove 420 formed at the head 420.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A battery comprising:
a cell cartridge module formed by stacking a plurality of cell cartridges, each of which generates current and is formed with a plurality of through holes at sides thereof;
a pack bracket for supporting the cell cartridge module, to enable stacking of the cell cartridge module; and
a plurality of long bolts inserted into the through holes, to extend through the cell cartridges so as to fasten the cell cartridge module to the pack bracket.

2. The battery according to claim 1, wherein each of the cell cartridges comprises a plurality of unit cells to generate current.

3. The battery according to claim 2, further comprising:
a cooling plate provided at a side of the cell cartridge module, to absorb heat transferred from the cell cartridge module.

4. The battery according to claim 3, wherein each of the cell cartridges comprises:
a plurality of unit cells to generate current; and
heat sink plates respectively provided at one-side portions of the unit cells, to receive heat generated from the unit cells.

5. The battery according to claim 4, wherein the heat sink plates are formed to enclose the unit cells, and each of the heat sink plates is formed, at sides thereof, with heat transfer portions to transfer heat to the cooling plate, respectively.

6. The battery according to claim 4, wherein the heat sink plates are provided at a top of the unit cells and a bottom of the unit cells, respectively.

7. The battery according to claim 4, further comprising:
a thermal pad provided between the heat sink plates and the cooling plate, to transfer heat from the heat sink plates to the cooling plate.

8. The battery according to claim 3, wherein:
the cooling plate is formed with a hollow cavity; and
a plurality of ribs is formed in the cavity, to define a flow passage.

9. The battery according to claim 3, wherein the cooling plate is formed such that cooling water passes through the cooling plate, to externally transfer the heat transferred to the cooling plate.

10. The battery according to claim 3, wherein the pack bracket is formed with a cooling plate seating portion, for seating of the cooling plate.

11. The battery according to claim 1, further comprising:
a bus bar module disposed at one side of the cell cartridge module, to connect the cell cartridges.

12. The battery according to claim 11, wherein the pack bracket is coupled with the bus bar module, and the cell cartridge module is seated on the pack bracket.

13. The battery according to claim 11, wherein the pack bracket is provided with a plurality of guides to support the cell cartridge module.

14. The battery according to claim 1, wherein the pack bracket is further provided with a sensor assembly coupled to the cell cartridge module, to measure current of the cell cartridges and a temperature of the cell cartridges.

15. The battery according to claim 13, wherein the plural guides are formed at corners of the pack bracket, to support corresponding corners of the cell cartridge module.

16. The battery according to claim 1, wherein the pack bracket comprises a central portion, and a peripheral portion protruded farther than the central portion such that, when the cell cartridge module is seated on the central portion, the peripheral portion of the cell cartridge module comes into contact with an inner surface of the peripheral portion, to support the cell cartridge module.

17. The battery according to claim 1, wherein lattice-shaped ribs are formed at a central portion of the pack bracket, to increase a rigidity of the central portion to support the cell cartridge module when the cell cartridge module is seated on the central portion.

18. The battery according to claim 1, wherein:
the cell cartridge module comprises at least two cell cartridge modules arranged on a same plane; and
a bridge bracket is provided between the cell cartridges respectively stacked on uppermost layers of the cell cartridge modules arranged on the same plane, to fix the cell cartridges.

19. The battery according to claim 18, further comprising:
a bus bar module disposed at one side of the cell cartridge modules, to connect the cell cartridges, and provided with a lug protruded to be coupled with the bridge bracket,
wherein the bridge bracket coupled to the lug is coupled with the cell cartridges stacked on uppermost layers of the cell cartridge modules arranged on the same plane, to fix the cell cartridge modules and the bus bar module.

20. The battery according to claim 18, wherein:
the bridge bracket is formed with openings, which are aligned with corresponding ones of the through holes formed through the cell cartridges when the bridge bracket is coupled to the cell cartridges; and
the long bolts extend through the aligned openings and through holes, to be fastened to the pack bracket.

21. The battery according to claim 11, wherein:
a coupling groove is formed in a recessed state at one side of the bus bar module; and
a coupling protrusion is formed in a protruded state at one side of the pack bracket such that the coupling protrusion is coupled with the coupling groove.

22. The battery according to claim 11, wherein a spacing guide is centrally formed at the pack bracket in a protruded state such that, when at least two cartridge modules arranged on a same plane are seated on the pack bracket, the spacing guide is arranged between the cell cartridge modules, to space the cell cartridge modules from each other.

23. The battery according to claim 11, wherein:
the bus bar module is further provided with a high-voltage current transmitter for externally transmitting current generated from the cell cartridge module; and
a seat is formed in a recessed state at one side of the pack bracket, for seating of the high-voltage current transmitter.

24. The battery according to claim 11, wherein the bus bar module comprises:
bus bars for electrically connecting the cell cartridges;
a bus bar plate formed with bus bar receiving grooves for receiving the bus bars, respectively; and
a plate cover coupled with the bus bar plate, to shield the bus bars received in the bus bar receiving grooves.
